(19) United States
(12) Patent Application Publication
(10) Pub. No.: US 2013/0321272 A1
(43) Pub. Date: Dec. 5, 2013

(54) WHEEL MOUSE

(71) Applicant: Xiang-Hui Deng, Taipei (TW)

(72) Inventor: Xiang-Hui Deng, Taipei (TW)

(73) Assignee: PRIMAX ELECTRONICS LTD., Taipei (TW)

(21) Appl. No.: 13/593,031

(22) Filed: Aug. 23, 2012

(30) Foreign Application Priority Data
Jun. 4, 2012 (CN) 201210181977.9

(51) Int. Cl. G06F 3/033

(52) U.S. Cl. 345/163

(57) ABSTRACT

The present invention discloses a wheel mouse including a wheel module, a trigger switch and a switch module. The trigger switch is located under the wheel module, which is capable of being pressed to generate a wheel button signal, so as to enable the wheel mouse to execute a wheel button command. The switch module is capable of controlling the wheel module to be operated in a first stage mode or a second stage mode. As a result, the wheel mouse not only has a switch function for the stage modes but also can generate the wheel button signal by pressing the wheel module.

### FIELD OF THE INVENTION

The present invention generally relates to a wheel mouse, and more particularly to a wheel mouse with different stage modes.

### BACKGROUND OF THE INVENTION

The computer system and the peripheral apparatuses thereof have already become an indispensable part of the daily life of every human being. It is necessary to operate the computer system by using a computer input device for a user, and thus it is not excessive to say that the computer input device is a communication medium between the computer system and the user. In general, the computer input device includes a mouse, a keyboard, a touch pad, and so on, wherein the mouse becomes the most popular input device because the user can hold the mouse with his palm to control a movement of a mouse cursor, which meets most users' operating habit.

FIG. 1 illustrates an external structural schematic view of a conventional wheel mouse, which is the wheel mouse disclosed in the U.S. Pat. No. 7,733,328 as well. Referring to FIG. 1, the wheel mouse 100 comprises a casing 101, a wheel module 105, a control button 110, a detector (not shown in the figures) and an encoder (not shown in the figures). Herein, the detector and the encoder are capable of detecting a movement of the casing 101 relative to a surface (such as a table surface where the wheel mouse is disposed on), and then outputting a corresponding signal to the computer system, so as to control a motion trajectory of a mouse cursor. With regard to the control button 110, it is designed additionally and capable of being pressed, so as to execute a specific control command, wherein the specific control command is defaulted in advance, such as a copy function, a letter selection function, and so on.

The structure of the wheel module 105 is described hereinafter. FIG. 2 illustrates a structural schematic view of a wheel module of a conventional wheel mouse. Referring to FIG. 2, the wheel module 105 comprises a roller wheel 300, a carriage 305, a pivot arm 380 and a DC motor 385. The roller wheel 300 is disposed in the carriage 305 and which is capable of being poked to rotated and thus generating a corresponding wheel rotation angle, so as to enable the computer system to execute a specific control command in response to the wheel rotation angle thereof, such as scrolling a computer window, zooming an image in or out, adjusting a sound volume, and so on. Herein, an internal of the roller wheel 300 has a relief surface 370, and when the pivot arm 380 thereof contacting with the relief surface 370 thereof is driven by the DC motor 385, a plurality stages are felt in response to the relief surface 370 as per round the roller wheel 300 is rotated. The stages can provide a function similar to scales, so as to differentiate execution degrees of the executed specific control command in response to the stages. For example, when each one of the stages is generated during the roller wheel 300 is rotated, the computer system scrolls three lines of the computer window.

In contrast, when the pivot arm 380 thereof is driven to leave the relief surface 370 by the DC motor 385 and the roller wheel 300 is poked by the user, the roller wheel 300 is continuously rotated for a period of time without being affected by the relief surface 370 since the pivot arm 380 is separated from the relief surface 370, i.e. the roller wheel 300 is rotated smoothly without any stage. As a result, the executed specific control command can directly execute the command with a maximum degree. For example, when the user desires to scroll the computer window from the top to the bottom, the user need to poke the roller wheel 300 only one time instead of to continuously rotate the roller wheel 300 by repeatedly poking the roller wheel 300, so as to enable the computer window to be scrolled continuously, and the rotation of the roller wheel 300 will be stopped until the computer window is scrolled to the desired location of the user.

FIG. 3 illustrates a structural explosion schematic view of a wheel module of a conventional wheel mouse. Referring to FIG. 3, a trigger switch 345 represented in FIG. 3 is disposed under the carriage 305. When a user presses the roller wheel 300, the roller wheel 300 brings the carriage 305 to move toward a lower side represented by an arrow 344, so as to enable the carriage 305 to press the trigger switch 345. As a result, the trigger switch 345 activates the DC motor 385 and then the DC motor 385 drives the pivot arm 380, so as to enable the pivot arm 380 to contact with the relief surface 370 contacting with the roller wheel 300, or enable the pivot arm 380 not to contact with the relief surface 370 contacting with the roller wheel 300.

Based upon the above mentioned description, it is understood that the conventional wheel mouse 100 is capable of providing two kinds of stage modes according to whether the pivot arm 380 thereof contacts with the relief surface 370 thereof or not, and the two kinds of stage modes are switched by pressing the roller wheel 300. Generally speaking, a function executed by pressing the roller wheel 300 is called a wheel button function, and the wheel button function is defaulted to determine that whether the computer window is rapidly scrolled upward or the computer window is rapidly scrolled downward in response to a movement of the wheel mouse 100 after the roller wheel 300 is pressed. It should be noted that most of users have been quite accustomed that the function of rapidly scrolling the computer window upward or rapidly scrolling the computer window downward can be executed by pressing the roller wheel 300. However, the conventional wheel mouse 100 modifies the original defaulted wheel button function to a function for switching between the two kinds of stage modes, which changes an operation habit of the wheel mouse to the user, such that the operation of the conventional wheel mouse 100 is inconvenient. As a result, it is desired to provide a wheel mouse for the users, which not only has a switch function for different stage modes, but also maintains the original operation habits of the wheel button.

### SUMMARY OF THE INVENTION

The present invention is directed to providing a wheel mouse, which not only can meet an original operation habit to the user, but also has a switch function for different stage modes.

In a preferred embodiment, the present invention provides a wheel mouse comprising:
a casing;
a wheel module, disposed within the casing and a roller wheel of the wheel module partially exposed outside the casing, wherein the roller wheel is capable of being poked to rotate;
a trigger switch, disposed within the casing and located under the wheel module, and capable of being pressed to generate a wheel button signal; and
a switch module, disposed within the casing and partially exposed outside the casing, and capable of being pressed to enable the wheel module to be operated in a first stage mode or a second stage mode, wherein the switch module comprising:
   a switch arm, located at a side of the wheel module and a first end of the switch arm is inserting into the roller wheel; and
   a press button, connected with a second end of the switch arm and partially exposed outside the casing, and capable of being pressed, so as to be moved upward or downward relative to the casing, and controlling whether the first end of the switch arm contacts with the roller wheel or not.

In a preferred embodiment, the press button comprises:
a press portion, partially exposed outside the casing, and capable of being pressed, so as to be moved upward or downward relative to the casing;
a connecting element, located under the press portion and connected with a second end of the switch arm. The connecting element is capable of being pushed to move relative to the casing by the press portion, and determining whether the first end of the switch arm contacts with the roller wheel or not in response to a location of the connecting element; and
a latch structure, disposed within the casing and located under the connecting element, and capable of moving the connecting element to a first location or a second location in response to a movement of the press portion.

In a preferred embodiment, when the connecting element is located at the first location and the press portion is pressed and moved, the latch structure moves the connecting element to the second location in response to the movement of the press portion, so as to enable the first end of the switch arm to contact with the roller wheel, and thus the wheel module is switched to the first stage mode, while when the connecting element is located at the second location and the press portion is pressed and moved, the latch structure moves the connecting element to the first location in response to the movement of the press portion, so as to enable the first end of the switch arm not to contact with the roller wheel, and thus the wheel module is switched to the second stage mode.

In a preferred embodiment, the connecting element comprises a fastening structure, the second end of the switch arm is capable of inserting into the fastening structure, so as to connect the connecting element with the switch arm, and the fastening structure and the connecting element are formed integrally.

In a preferred embodiment, the latch structure comprises:
a base body;
a containing portion, disposed at a bottom of the base body;
an elastic element, disposed within the containing portion for providing an elastic force;
a displacement element, disposed within the base body and located over the elastic element for being moved upward or downward relative to the base body;
a slide portion, disposed on the displacement element; and
a fastening hook, disposed within the containing portion and a first end of the fastening hook inserted into the slide portion, wherein when the first end of the fastening hook is located at a first fastening location within the slide portion and the press portion is pressed and moved, the displacement element is pushed to move relative to the base body by the press portion, so as to enable the elastic element to be compressed and to accumulate the elastic force, and the first end of the fastening hook is moved from the first fastening location to a second fastening location in response to the movement of the displacement element, so as to enable the connecting element to be moved to the second location.

In a preferred embodiment, when the first end of the fastening hook is located at the second fastening location within the slide portion and the press portion is pressed and moved, the displacement element is pushed to move relative to the base body within the containing portion by the press portion, so as to enable the first end of the fastening hook to leave the second fastening location and move within the slide portion in response to the movement of the displacement element, the elastic element is no longer being compressed and thus provides the elastic force to the displacement element, so as to enable the displacement element to be pushed and moved by the elastic element, and the first end of the fastening hook is moved to the first fastening location in response to the movement of the displacement element, so as to enable the connecting element to be moved to the first location.

In a preferred embodiment, the wheel module further comprises:
a wheel swing base, disposed within the casing and capable of being swung relative to the casing, and capable of containing the roller wheel therein;
a fixing shaft, disposed on the wheel swing base and passed through the roller wheel for fixing the roller wheel on the wheel swing base and enabling the roller wheel to be rotated relative to the wheel swing base; and
an encoder, disposed adjacent to the wheel swing base for calculating the rotation of the roller wheel and thus correspondingly outputting a wheel rotation angle.

In a preferred embodiment, the switch module further comprises an another elastic element disposed on the wheel swing base, a first end of the another elastic element contacts with the switch arm, a second end of the another elastic element is held on a hook portion of the wheel swing base, so as to enable the another elastic element to provide an elastic force to the switch arm, and the first end of the switch arm contacts with the roller wheel.

In a preferred embodiment, the roller wheel comprises:
a dent portion, surrounding the fixing shaft, and the first end of the switch arm capable of inserting into the dent portion; and
a plurality of protrusion structures, disposed on an inner surface of the dent portion, so as to form the inner surface of the dent portion as a relief surface, wherein when the first end of the switch arm contacts with the plurality of protrusion structures, the wheel module is switched to the first stage mode.

In a preferred embodiment, the trigger switch is disposed under the wheel swing base, and when the roller wheel is pressed, the wheel swing base is downward moved relative to the casing to press trigger switch, so as to enable the trigger switch to be triggered and thus to generate the wheel button signal.

In a preferred embodiment, the wheel mouse of the present invention further comprises a circuit board and an encoder, wherein the circuit board is disposed within the casing and electrically connected with the trigger switch, and the encoder is capable of transmitting the wheel button signal generated by the trigger switch and a wheel rotation angle generated by the encoder.

In a preferred embodiment, the casing comprises:
a bottom base for carrying a circuit board and the wheel module thereon; and
a top cover, covering the bottom base, and the top cover comprising a first top cover aperture and a second top cover aperture, the first top cover aperture and the second top cover aperture are disposed at an upper surface of the top cover, wherein the roller wheel passes through the first top cover aperture and is partially exposed outside the top cover, and the press button passes through the second top cover aperture and is partially exposed outside the top cover.

### BRIEF DESCRIPTION OF THE DRAWINGS

FIG. 1 illustrates an external structural schematic view of a conventional wheel mouse.

FIG. 2 illustrates a structural schematic view of a wheel module of a conventional wheel mouse.

FIG. 3 illustrates a structural explosion schematic view of a wheel module of a conventional wheel mouse.

FIG. 4 illustrates an external structural schematic view of a wheel mouse according to a preferred embodiment of the present invention.

FIG. 5 illustrates a partial structural schematic view of a wheel module of a wheel mouse switched to a first stage mode according to a preferred embodiment of the present invention.

FIG. 6 illustrates a partial structural schematic view from another angle of view of a wheel module of a wheel mouse switched to a first stage mode according to a preferred embodiment of the present invention.

FIG. 7 illustrates a partial structural cross-sectional schematic view of a wheel module of a wheel mouse switched to a first stage mode according to a preferred embodiment of the present invention.

FIG. 8 illustrates a partial structural cross-sectional schematic view of a latch structure of a wheel mouse according to a preferred embodiment of the present invention.

FIG. 9 illustrates a partial structural schematic view of a latch structure of a wheel mouse switched to a first stage mode according to a preferred embodiment of the present invention.

FIG. 10 illustrates a structural schematic side view of a wheel module and a switch arm of a wheel mouse switched to a first stage mode according to a preferred embodiment of the present invention.

FIG. 11 illustrates a partial structural schematic view of a wheel module of a wheel mouse switched to a second stage mode according to a preferred embodiment of the present invention.

FIG. 12 illustrates a partial structural schematic view from another angle of view of a wheel module of a wheel mouse switched to a second stage mode according to a preferred embodiment of the present invention.

FIG. 13 illustrates a partial structural schematic view of a latch structure of a wheel mouse switched to a second stage mode according to a preferred embodiment of the present invention.

FIG. 14 illustrates a structural schematic side view of a wheel module and a switch arm of a wheel mouse switched to a second stage mode according to a preferred embodiment of the present invention.

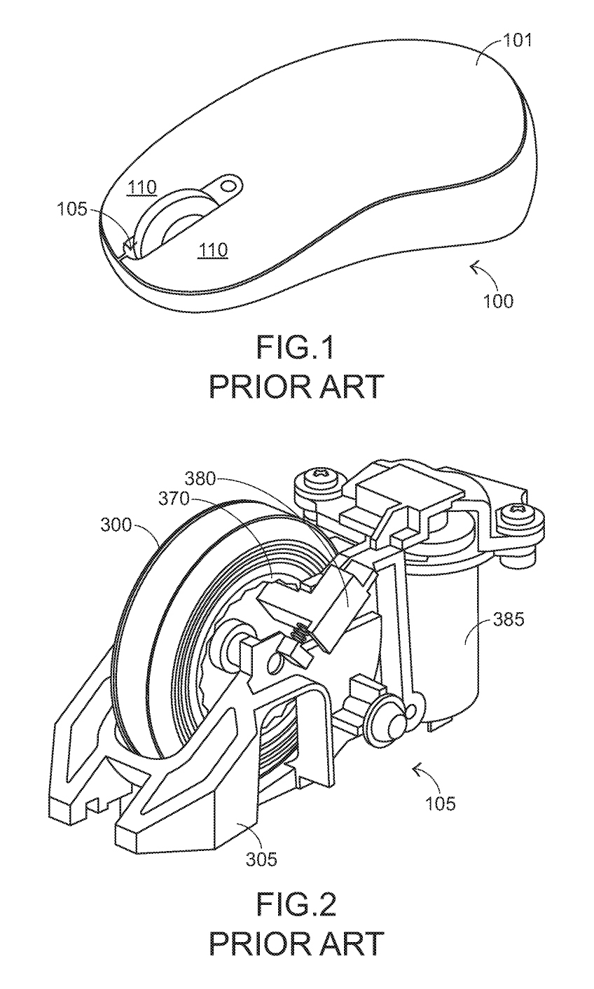

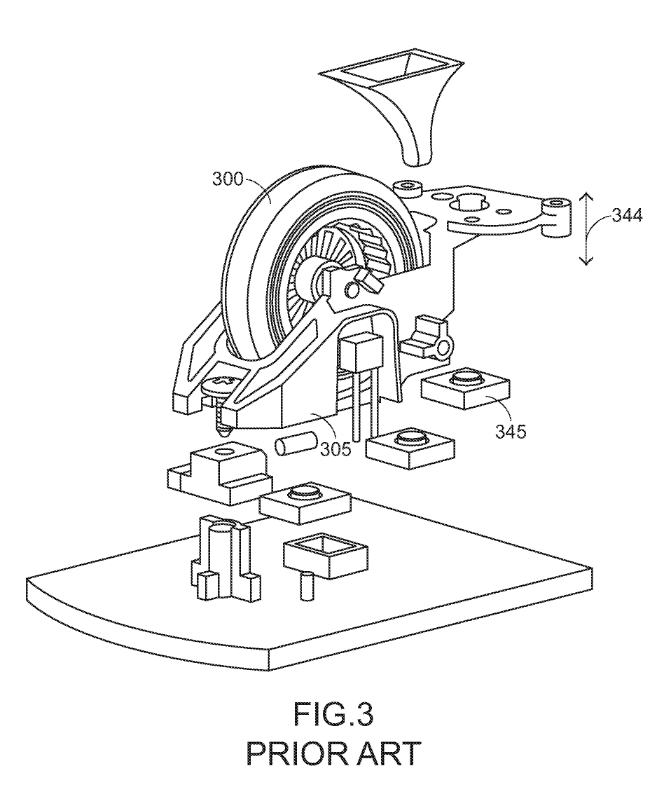

### DETAILED DESCRIPTION OF THE PREFERRED EMBODIMENT

Reference will now be made in detail to specific embodiments of the present invention. Examples of these embodiments are illustrated in the accompanying drawings. While the invention will be described in conjunction with these specific embodiments, it will be understood that it is not intended to limit the invention to these embodiments. In fact, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well-known process operations are not described in detail in order not to obscure the present invention.

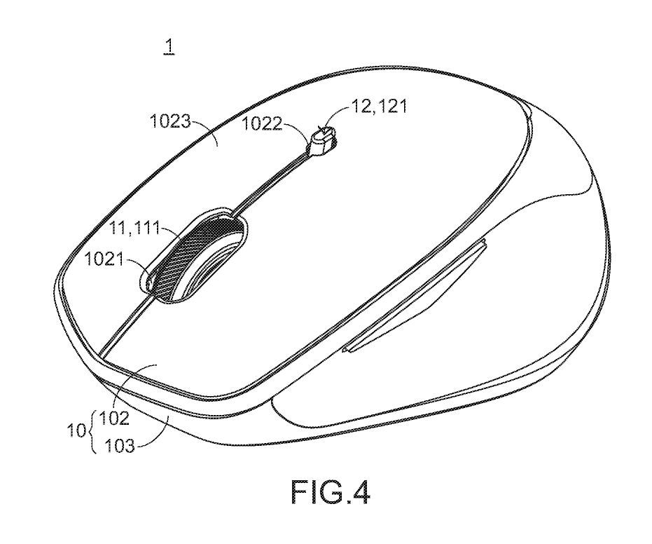

FIG. 4 illustrates an external structural schematic view of a wheel mouse according to a preferred embodiment of the present invention. Referring to FIG. 4, the wheel mouse 1 comprises a casing 10, a wheel module 11 and a switch module 12, and the casing 10 comprises a top cover 102 and a bottom base 103. FIG. 4 merely illustrates a roller wheel 111 of the wheel module 11 and a press button 121 of the switch module 12, wherein the roller wheel 111 is capable of rotating by being poked, and the press button 121 is capable of being pressed, so as to enable the wheel module 11 to be operated in a first stage mode or a second stage mode. In the casing 10, the top cover 102 covers the bottom base 103 and has a first top cover aperture 1021 and a second top cover aperture 1022, wherein both of the first top cover aperture 1021 and the second top cover aperture 1022 are disposed on an upper surface 1023 of the top cover 102, and the wheel 111 passes through the first top cover aperture 1021 and is partially exposed outside the top cover 102, while the press button 121 passes through the second top cover aperture 1022 and is partially exposed outside the top cover 102.

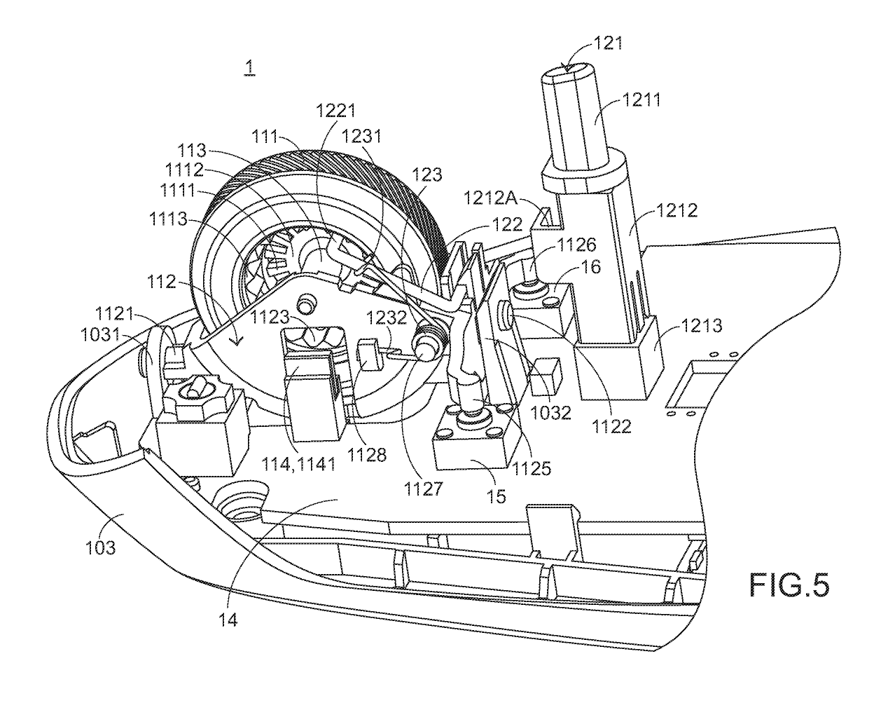

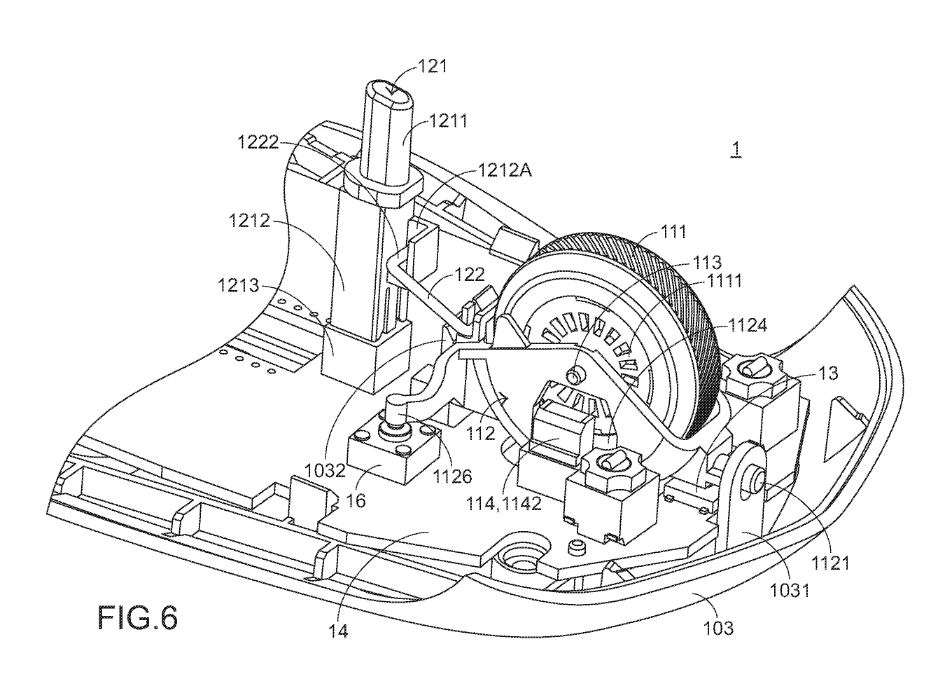

An internal structure of the wheel mouse 1 is described hereinafter. FIG. 5 illustrates a partial structural schematic view of a wheel module of a wheel mouse switched to a first stage mode according to a preferred embodiment of the present invention, while FIG. 6 illustrates a partial structural schematic view from another angle of view of a wheel module of a wheel mouse switched to a first stage mode according to a preferred embodiment of the present invention. Referring to FIG. 5 and FIG. 6 together, the bottom base 103 of the wheel mouse 1 comprises a first fixing post 1031 and a second fixing post 1032, wherein the first fixing post 1031 and the second fixing post 1032 are respectively formed by extending from the bottom base 103, i.e. the first fixing post 1031 and the second fixing post 1032 are formed integrally with the bottom base 103. Besides the roller wheel 111, the wheel module 11 of the wheel mouse 1 further comprises a wheel swing base 112, a fixing shaft 113 and an encoder 114.

The wheel swing base 112 is capable of containing the roller wheel 111 therein, and which is disposed within the casing 10 and capable of being swung relative to the casing 10. In detail, a front end 1121 of the wheel swing base 112 is disposed on the first fixing post 1031, and a rear end 1122 of the wheel swing base 112 is disposed on the second fixing post 1032, and thus the wheel swing base 112 is enable to be leftward or rightward swung relative to the casing 10. The fixing shaft 113 is disposed on the wheel swing base 112 and passes through the roller wheel 111, and is capable of fixing the roller wheel 111 on the wheel swing base 112 and enabling the roller wheel 111 to be rotated relative to the wheel swing base 112. The encoder 114 is disposed adjacent to the wheel swing base 111 and capable of calculating the rotation of the roller wheel 111 and thus correspondingly outputting a wheel rotation angle. In the present preferred embodiment, the encoder 114 is an optical encoder, and the encoder 114 includes a light emitter 1141 and a light receiver 1142, wherein the light emitter 1141 is disposed at a first side of the wheel swing base 112 and capable of emitting a light beam, while the light receiver 1142 is disposed at a second side of the wheel swing base 112 and capable of receiving the light beam passing through the slits of a grating structure 1111 of the roller wheel 111. In addition, the light receiver 1142 is capable of calculating the wheel rotation angle in response to the light beam being intermittently interrupted by the grating structure 1111. In contrast, the wheel swing base 112 further comprises a first aperture 1123 and a second aperture 1124, they respectively correspond to the light emitter 1141 and the light receiver 1142, so as to enable the light beam generated by the light emitter 1141 to pass through the roller wheel 111.

In other preferred embodiments, the encoder can be applied by using a mechanical encoder as well, while the fixing shaft and the wheel are formed integrally, and an end of the fixing shaft inserts into the encoder, so as to enable the encoder to calculate the wheel rotation angle of the wheel according to the rotation of the fixing shaft there. In addition, the wheel swing base can further be disposed with a dent capable of containing the encoder therein. As a result, it is unnecessary to dispose the first aperture and the second aperture on the wheel swing base corresponding to the light emitter and the light receiver.

As illustrated in FIG. 5 and FIG. 6, the wheel mouse 1 further comprises a trigger switch 13, a circuit board 14, a first swing switch 15 and a second swing switch 16. The circuit board 14 is disposed on the bottom base 103 of the casing 10, and all of the trigger switch 13, the first swing switch 15, the second swing switch 16 and the encoder 114 are disposed on the circuit board 14. The trigger switch 13 is located under the wheel swing base 112 of the wheel module 11 and capable of being pressed by the wheel swing base 112, so as to generate a wheel button signal. Herein, the action that the trigger switch 13 is pressed by the wheel swing base 112 is enabled to be activated in response to the wheel swing base 112 being moved downward relative to the casing 10 when the roller wheel 111 exposed outside the casing 10 is pressed. The first swing switch 15 is located at the first side of the rear end 1122 of the wheel swing base 112 and capable of being pressed by a first extension arm 1125 of the wheel swing base 112 in response to a swing of the wheel swing base 112, so as to generate a first swing signal. Similarly, the second swing switch 16 is located at the second side of the rear end 1122 of the wheel swing base 112 and capable of being pressed by a second extension arm 1126 of the wheel swing base 112 in response to a swing of the wheel swing base 112, so as to generate a second swing signal. As a result, it should be understood that the wheel mouse 1 is a wheel mouse with a wheel tilt function. Besides, the circuit board 14 is electrically connected with all of the trigger switch 13, the encoder 114, the first swing switch 15 and the second swing switch 16 and capable of transmitting all of the wheel button signal generated by the trigger switch 13, the wheel rotation angle generated by the encoder 114, the first swing signal generated by the first swing switch 15 and the second swing signal generated by the second swing switch 16.

In the wheel module 11, the roller wheel 111 further comprises a dent portion 1112 and a plurality of protrusion structures 1113, wherein the dent portion 1112 surrounds the fixing shaft 113 and is adjacent to the grating structure 1111, and the plurality of protrusion structures 1113 are disposed on an inner surface of the dent portion 1112, so as to form the inner surface of the dent portion 1112 as a relief surface. On the other hand, in the switch module 12, besides the press button 121, the switch module 12 further comprises a switch arm 122 and a first elastic element 123. Herein, the switch arm 122 is located at a side of the wheel swing base 112 of the wheel module 11, and a first end 1221 of the switch arm 122 inserts into the dent portion 1112 of the wheel 11, while a second end 1222 of the switch arm 122 connects with the press button 121. In addition, the first elastic element 123 is fit onto an extension post 1127 of the wheel swing base 112, and a first end 1231 of the first elastic element 123 contacts with the switch arm 122, while a second end 1232 of the first elastic element 123 is held on a hook portion 1128 of the wheel swing base 112, so as to enable the first elastic element 123 to provide an elastic force to the switch arm 122 and to enable the first end 1221 of the switch arm 122 to contact with the plurality of protrusion structures 1113 of the roller wheel 111. In the present preferred embodiment, the first elastic element is a torsion spring. As a result, when the first end 1221 of the switch arm 122 contacts with the plurality of protrusion structures 1113, the wheel module 11 is switched to the first stage mode, i.e. a plurality stages are felt as per round the roller wheel 111 is rotated. For example, if the wheel module 11 is switched to the first stage mode and the user pokes the roller wheel 111, a computer system thereof scrolls three lines of a computer window when each one of the stages is generated by the roller wheel 111.

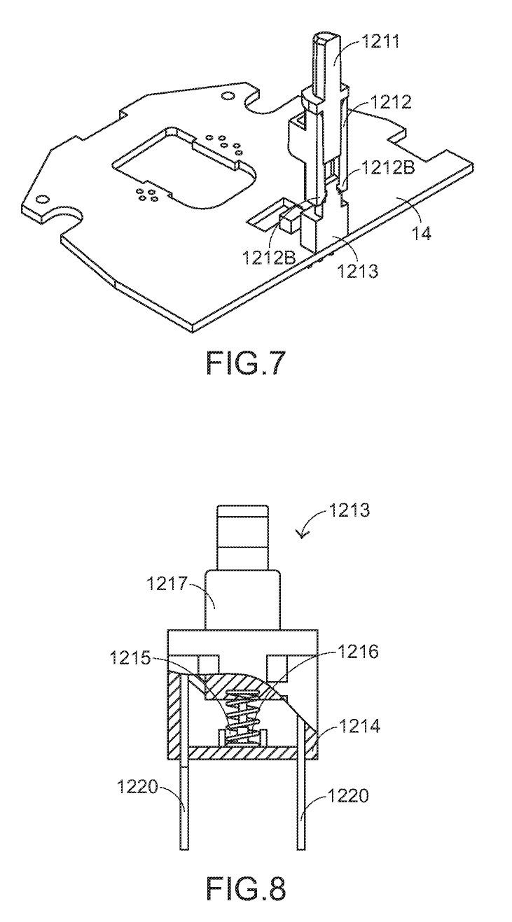

FIG. 7 illustrates a partial structural cross-sectional schematic view of a wheel module of a wheel mouse switched to a first stage mode according to a preferred embodiment of the present invention. Referring to FIG. 5, FIG. 6 and FIG. 7 together, the press button 121 of the switch module 12 is partially exposed outside the casing 10 and capable of being pressed, so as to be moved upward or downward relative to the casing 10, and controlling whether the first end 1221 of the switch arm 122 contacts with the plurality of protrusion structures 1113 of the roller wheel 111 or not. In addition, the press button 121 comprises a press portion 1211, a connecting element 1212 and a latch structure 1213 (colloquially called a Door Lock or a Push Push Lock), wherein the press portion 1211 is partially exposed outside the top cover 102 via the second top cover aperture 1022, which is capable of being pressed, so as to be moved upward or downward relative to the casing 10. Moreover, the connecting element 1212 is located under the press portion 1211 and respectively connects with the press portion 1211 and the second end 1222 of the switch arm 122, which is capable of being pushed by the press portion 1211, so as to be moved relative to the casing 10. Here, whether the first end 1221 of the switch arm 122 contacts with the plurality of protrusion structures 1113 of the roller wheel 111 or not is determined according to the location of the connecting element 1212. The connecting element 1212 comprises a fastening structure 1212A, wherein the second end 1222 of the switch arm 122 is capable of inserting into the fastening structure 1212A, so as to connect the connecting element 1212 and the switch arm 122. In the present preferred embodiment, the fastening structure 1212A is formed integrally with the connecting element 1212. Further, the latch structure 1213 is disposed within the casing 10 and located under the connecting element 1212, wherein, an end 1212B of the connecting element 1212 is connected with the latch structure 1213 with a clamping manner, as illustrated in FIG. 7. Furthermore, the latch structure 1213 is capable of moving the connecting element 1212 to a first location P1 or a second location P2 in response to the movement of the press portion 1211.

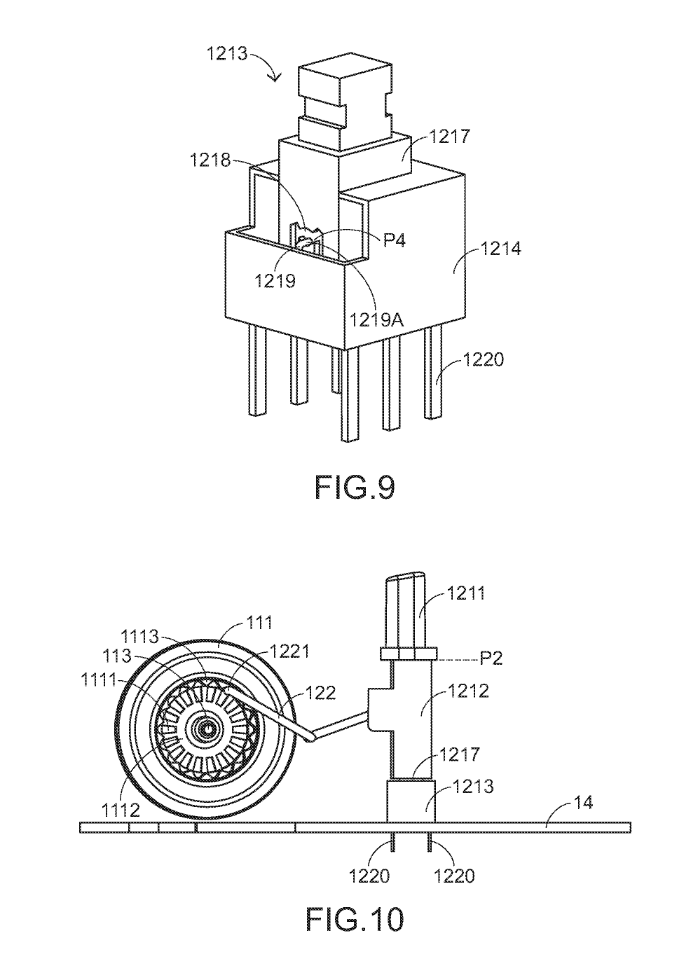

An internal structure of the latch structure 1213 is described hereinafter. FIG. 8 illustrates a partial structural cross-sectional schematic view of a latch structure of a wheel mouse according to a preferred embodiment of the present invention, and FIG. 9 illustrates a partial structural schematic view of a latch structure of a wheel mouse switched to a first stage mode according to a preferred embodiment of the present invention. In addition, FIG. 10 illustrates a structural schematic side view of a wheel module and a switch arm of a wheel mouse switched to a first stage mode according to a preferred embodiment of the present invention. Referring to FIG. 8 and FIG. 9 together first, the latch structure 1213 comprises a base body 1214, a containing portion 1215, a second elastic element 1216, a displacement element 1217, a slide portion 1218, a fastening hook 1219 and a plurality of pins 1220, wherein the containing portion 1215 is disposed at a bottom of the base body 1214, while the second elastic element 1216 is disposed within the containing portion 1215, which is capable of providing an elastic force. In the present preferred embodiment, the second elastic element 1214 is a compression spring. The displacement element 1217 is disposed within the base body 1214 and located over the second elastic element 1216, and is capable of being moved upward or downward relative to the base body 1214, while the slide portion 1218 is disposed on the displacement element 1217. Here, the displacement element 1217 is clamped by the end 1212B of the connecting element 1212, so as to join the latch structure 1213 and the connecting element 1212 together. The fastening hook 1219 is disposed within the containing portion 1215, and a second end (not shown in the figures) of the fastening hook 1219 is held within the containing portion 1215, while a first end 1219A of the fastening hook 1219 inserts into the slide portion 1218.

In the present preferred embodiment, the latch structure 1213 is plugged onto the circuit board 14 via a plurality of pins 1220. Because the latch structure 1213 is operated via the above mentioned elements mechanically without generating any electronic signal, the plurality of pins 1220 thereof are not used for transmitting the electronic signal, but are used for fixing the latch structure 1213 on the circuit board 14. However, in the other preferred embodiments, the circuit board can be disposed with an aperture corresponding to the latch structure, so as to enable the latch structure to be passed through the aperture and thus held on the bottom base. Of course, the latch structure can be disposed without any pin as well.

Referring to FIG. 5 and FIG. 6 again, when the user desires to use the wheel mouse 1 having stages, the user presses the press portion 1211 of the press button 121 downward and thus the press portion 1211 pushes the connecting element 1212, so as to enable the connecting element 1212 to be moved downward relative to the casing 10. Herein, the latch structure 1213 moves the connecting element 1212 to the second location P2 in response to the press portion 1211 being moved downward. Referring to FIG. 8 and FIG. 9 again, the actions of all of the elements of the latch structure 1213 during the connecting element 1212 moving to the second location P2 are illustrated as below. When the connecting element 1212 is pushed and moved by the press portion 1211, the displacement element 1217 connected with the connecting element 1212 is pushed by the press portion 1211 as well, so as to be moved relative to the base body 1214. At the same time, the first end 1219A of the fastening hook 1219 is moved within the slide portion 1218, and the second elastic element 1216 is compressed, so as to accumulate an elastic force. When the first end 1219A of the fastening hook 1219 is moved to a second fastening location P4 of the slide portion 1218 and the first end 1219A of the fastening hook 1219 is held on the second fastening location P4, the connecting element 1212 connecting with the displacement element 1217 is held on the second location P2.

On the other hand, in response to the connecting element 1212 being moved to the second location P2, the fastening structure 1212A of the connecting element 1212 is also moved consequentially, so as to enable the second end 1222 of the switch arm 122 connecting with the fastening structure 1212A to be moved downward. At the same time, in response to the second end 1222 of the switch arm 122 being moved downward, the first end 1221 of the switch arm 122 is moved upward, and the first end 1221 of the switch arm 122 contacts with the plurality of protrusion structures 1113 of the roller wheel 111. At this time, the wheel module 11 is switched to the first stage mode as illustrated in FIG. 10.

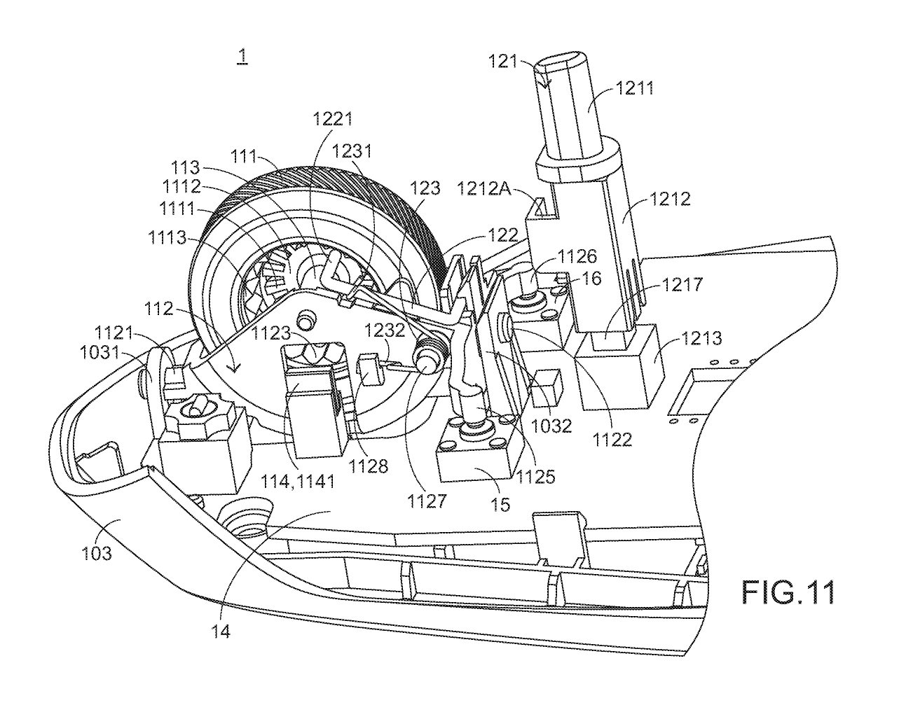

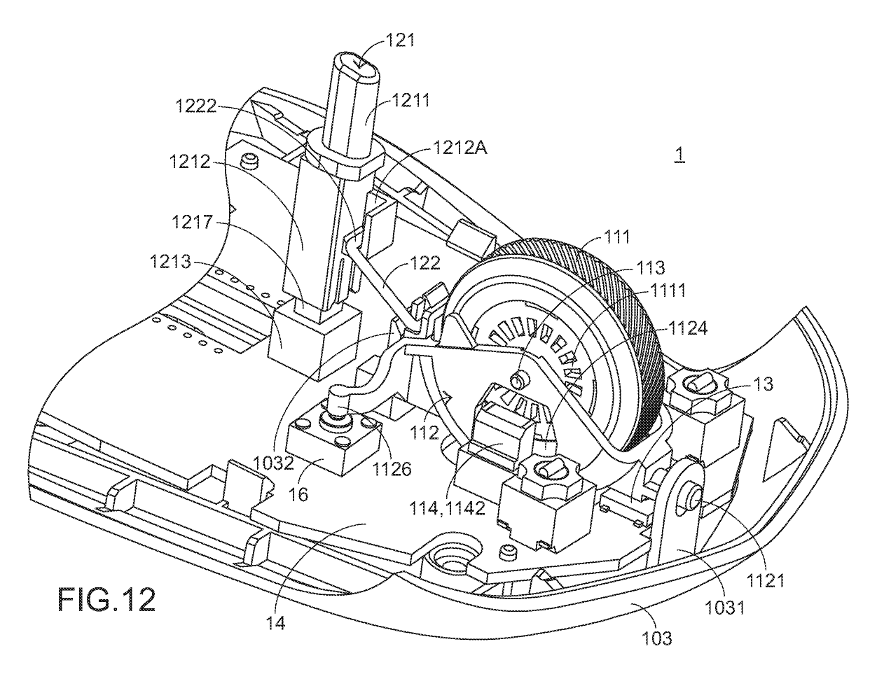

FIG. 11 illustrates a partial structural schematic view of a wheel module of a wheel mouse switched to a second stage mode according to a preferred embodiment of the present invention, while FIG. 12 illustrates a partial structural schematic view from another angle of view of a wheel module of a wheel mouse switched to a second stage mode according to a preferred embodiment of the present invention. Referring to FIG. 11 and FIG. 12 together, when the user desires to use the wheel mouse 1 without any stage, the user presses the press portion 1211 of the press button 121 downward again and thus the press portion 1211 pushes the connecting element 1212, so as to enable the connecting element 1212 to be slightly moved downward and then further moved upward relative to the casing 10. Herein, the latch structure 1213 moves the connecting element 1212 from the second location P2 to the first location P1 in response to the press portion 1211 being moved downward.

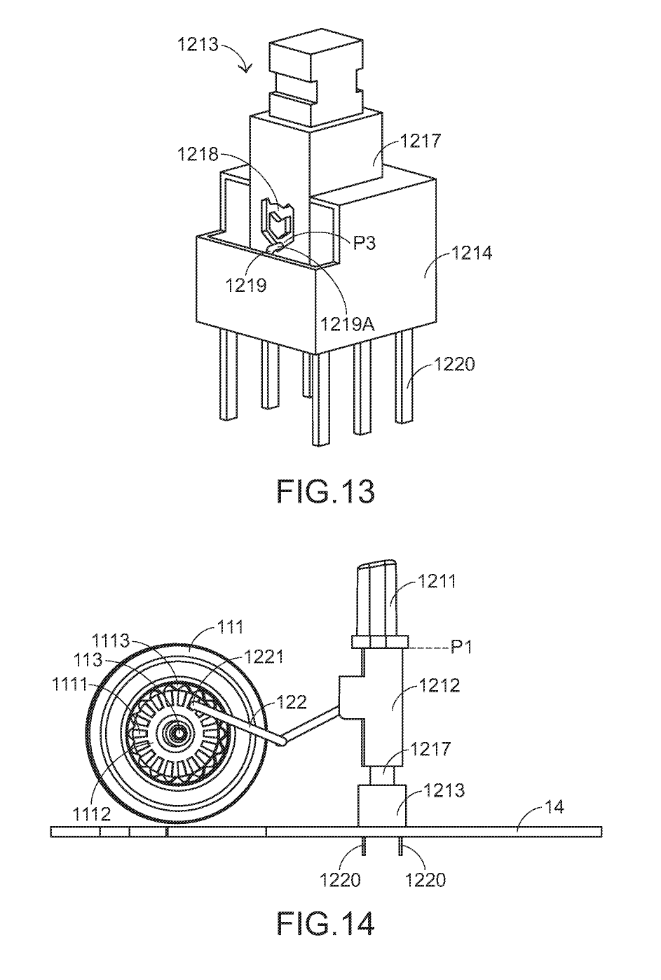

FIG. 13 illustrates a partial structural schematic view of a latch structure of a wheel mouse switched to a second stage mode according to a preferred embodiment of the present invention. In addition, FIG. 14 illustrates a structural schematic side view of a wheel module and a switch arm of a wheel mouse switched to a second stage mode according to a preferred embodiment of the present invention. Referring to FIG. 8 and FIG. 13 together hereinafter, in the latch structure 1213, when the connecting element 1212 is pushed and moved by the press portion 1211, the displacement element 1217 connected with the connecting element 1212 is pushed by the press portion 1211, so as to be moved relative to the base body 1214. At the same time, the first end 1219A of the fastening hook 1219 is separated from the second fastening location P4 in response to the movement of the displacement element 1217 and moved within the slide portion 1218, so as to enable the second elastic element 1216 not to be compressed any more and further to release the elastic force. After that, the second elastic element 1216 provides the elastic force to the displacement element 1217, so as to move the displacement element 1217 upward. When the first end 1219A of the fastening hook 1219 is moved to a first fastening location P3 of the slide portion 1218 and the first end 1219A of the fastening hook 1219 is held on the first fastening location P3, the connecting element 1212 connecting with the displacement element 1217 is held on the first location P1.

On the other hand, in response to the connecting element 1212 being moved to the first location P1, the fastening structure 1212A of the connecting element 1212 is moved consequentially as well, so as to enable the fastening structure 1212A pushes the second end 1222 of the switch arm 122, and the second end 1222 of the switch arm 122 is moved upward. At the same time, in response to the second end 1222 of the switch arm 122 being moved upward, the first end 1221 of the switch arm 122 is moved downward, and the first end 1221 of the switch arm 122 not contacts with the plurality of protrusion structures 1113 of the roller wheel 111. At this time, the wheel module 11 is switched from the first stage mode to the second stage mode as illustrated in FIG. 14. If the wheel module 11 is switched to the second stage mode and the user pokes the roller wheel 111, the computer system thereof rapidly and continuously scrolls the computer window when there is no stage generated by the roller wheel 111 and the roller wheel 111 continuously is rolled for a specific time period.

In a word, when the wheel module 11 is switched to the first stage mode, the wheel mouse 1 thereof provides a wheel rotation function having stages, the connecting element 1212 is located at the second location P2, and the first end 1219A of the fastening hook 1219 is located at the second fastening location P4 of the slide portion 1218, so as to enable the first end 1221 of the switch arm 122 to contact with the plurality of protrusion structures 1113 of the roller wheel 111. However, when the wheel module 11 is switched to the second stage mode, the wheel mouse 1 thereof provides a wheel rapid rotation function without any stage, the connecting element 1212 is located at the first location P1, and the first end 1219A of the fastening hook 1219 is located at the first fastening location P3 of the slide portion 1218, so as to enable the first end 1221 of the switch arm 122 not to contact with the plurality of protrusion structures 1113 of the roller wheel 111.

According to the above mentioned descriptions, it should be understood that the wheel mouse of the present invention can be switched between different stage modes by the press button and maintains the original wheel button function that is used to be used by the user. In addition, a structure of the switch module of the wheel mouse of the present invention is simple and can be switched between different stage modes without applying with the DC motor. As a result, it not only has a benefit for assembling the elements inside the wheel mouse, but also has an advantage of lower cost.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A wheel mouse, comprising:
a casing;
a wheel module, disposed within the casing and a roller wheel of the wheel module partially exposed outside the casing, wherein the roller wheel is capable of being poked to rotate;
a trigger switch, disposed within the casing and located under the wheel module, and capable of being pressed to generate a wheel button signal; and
a switch module, disposed within the casing and partially exposed outside the casing, and capable of being pressed to enable the wheel module to be operated in a first stage mode or a second stage mode, wherein the switch module comprising:
a switch arm, located at a side of the wheel module and a first end of the switch arm is inserting into the roller wheel; and
a press button, connected with a second end of the switch arm and partially exposed outside the casing, and capable of being pressed, so as to be moved upward or downward relative to the casing, and controlling whether the first end of the switch arm contacts with the roller wheel or not.

2. The wheel mouse as claimed in claim 1, wherein the press button comprises:
a press portion, partially exposed outside the casing, and capable of being pressed, so as to be moved upward or downward relative to the casing;
a connecting element, located under the press portion and connected with a second end of the switch arm, wherein the connecting element is capable of being pushed to move relative to the casing by the press portion, and determining whether the first end of the switch arm contacts with the roller wheel or not in response to a location of the connecting element; and
a latch structure, disposed within the casing and located under the connecting element, and capable of moving the connecting element to a first location or a second location in response to a movement of the press portion.

3. The wheel mouse as claimed in claim 2, wherein when the connecting element is located at the first location and the press portion is pressed and moved, the latch structure moves the connecting element to the second location in response to the movement of the press portion, so as to enable the first end of the switch arm to contact with the roller wheel, and thus the wheel module is switched to the first stage mode, while when the connecting element is located at the second location and the press portion is pressed and moved, the latch structure moves the connecting element to the first location in response to the movement of the press portion, so as to enable the first end of the switch arm not to contact with the roller wheel, and thus the wheel module is switched to the second stage mode.

4. The wheel mouse as claimed in claim 2, wherein the connecting element comprises a fastening structure, the second end of the switch arm is capable of inserting into the fastening structure, so as to connect the connecting element with the switch arm, and the fastening structure and the connecting element are formed integrally.

5. The wheel mouse as claimed in claim 2, wherein the latch structure comprises:
a base body;
a containing portion, disposed at a bottom of the base body;
an elastic element, disposed within the containing portion for providing an elastic force;
a displacement element, disposed within the base body and located over the elastic element for being moved upward or downward relative to the base body;
a slide portion, disposed on the displacement element; and
a fastening hook, disposed within the containing portion and a first end of the fastening hook inserted into the slide portion, wherein when the first end of the fastening hook is located at a first fastening location within the slide portion and the press portion is pressed and moved, the displacement element is pushed to move relative to the base body by the press portion, so as to enable the elastic element to be compressed and to accumulate the elastic force, and the first end of the fastening hook is moved from the first fastening location to a second fastening location in response to the movement of the displacement element, so as to enable the connecting element to be moved to the second location.

6. The wheel mouse as claimed in claim 5, wherein when the first end of the fastening hook is located at the second fastening location within the slide portion and the press portion is pressed and moved, the displacement element is pushed to move relative to the base body within the containing portion by the press portion, so as to enable the first end of the fastening hook to leave the second fastening location and move within the slide portion in response to the movement of the displacement element, the elastic element is no longer being compressed and thus provides the elastic force to the displacement element, so as to enable the displacement element to be pushed and moved by the elastic element, and the first end of the fastening hook is moved to the first fastening location in response to the movement of the displacement element, so as to enable the connecting element to be moved to the first location.

7. The wheel mouse as claimed in claim 1, wherein the wheel module further comprises:
a wheel swing base, disposed within the casing and capable of being swung relative to the casing, and capable of containing the roller wheel therein;
a fixing shaft, disposed on the wheel swing base and passed through the roller wheel for fixing the roller wheel on the wheel swing base and enabling the roller wheel to be rotated relative to the wheel swing base; and
an encoder, disposed adjacent to the wheel swing base for calculating the rotation of the roller wheel and thus correspondingly outputting a wheel rotation angle.

8. The wheel mouse as claimed in claim 7, wherein the switch module further comprises an another elastic element disposed on the wheel swing base, a first end of the another elastic element contacts with the switch arm, a second end of the another elastic element is held on a hook portion of the wheel swing base, so as to enable the another elastic element to provide an elastic force to the switch arm, and the first end of the switch arm contacts with the roller wheel.

9. The wheel mouse as claimed in claim 7, wherein the roller wheel comprises:
a dent portion, surrounding the fixing shaft, and the first end of the switch arm capable of inserting into the dent portion; and
a plurality of protrusion structures, disposed on an inner surface of the dent portion, so as to form the inner surface of the dent portion as a relief surface, wherein when the first end of the switch arm contacts with the plurality of protrusion structures, the wheel module is switched to the first stage mode.

10. The wheel mouse as claimed in claim 7, wherein the trigger switch is disposed under the wheel swing base, and when the roller wheel is pressed, the wheel swing base is downward moved relative to the casing to press trigger switch, so as to enable the trigger switch to be triggered and thus to generate the wheel button signal.

11. The wheel mouse as claimed in claim 1, further comprising a circuit board and an encoder, wherein the circuit board is disposed within the casing and electrically connected with the trigger switch, and the encoder is capable of transmitting the wheel button signal generated by the trigger switch and a wheel rotation angle generated by the encoder.

12. The wheel mouse as claimed in claim 1, wherein the casing comprises:
a bottom base for carrying a circuit board and the wheel module thereon; and
a top cover, covering the bottom base, and the top cover comprising a first top cover aperture and a second top cover aperture, the first top cover aperture and the second top cover aperture are disposed at an upper surface of the top cover, wherein the roller wheel passes through the first top cover aperture and is partially exposed outside the top cover, and the press button passes through the second top cover aperture and is partially exposed outside the top cover.
